(19) United States
(12) Patent Application Publication
(10) Pub. No.: US 2011/0276992 A1
(43) Pub. Date: Nov. 10, 2011

(54) CHANNEL RECALL REMINDER SYSTEM, SIGNAL SOURCE RECALL REMINDER SYSTEM AND RELATED METHODS

(76) Inventor: Meng-Hsiu Tsai, Taichung City (TW)

(21) Appl. No.: 13/104,024

(22) Filed: May 10, 2011

(30) Foreign Application Priority Data
May 10, 2010 (TW) 099114767

(51) Int. Cl. H04H 60/29

(52) U.S. Cl. 725/9

(57) ABSTRACT

A channel recall reminder system includes a detecting device and a reminder device. The detecting device is used for detecting a channel status of a signal source to generate a detecting result. The reminder device is coupled to the detecting device, and is used for referring to the detecting result to determine whether to provide a reminder of performing a channel recall operation.

### BACKGROUND OF THE INVENTION

1. Field of the Invention

The present invention relates to a reminder system, and more particularly, to a reminder system capable of automatically reminding the user to perform a channel or signal source recall operation, and a method thereof.

2. Description of the Prior Art

As technology progresses, the number of functions supported by multi-media apparatus also grows rapidly. A television (TV), for instance, not only has a great number of channels and programs available, but also can be connected to other electronic devices such as digital versatile disc (DVD) players, personal computers, notebook computers or video game players, etc. Thus, users can choose to watch different channels or switch the TV directly to a mode for receiving signals from external electronic apparatuses (e.g., signals from a composite video connector) and display pictures converted from the received signals on a screen according to different user requirements. Currently, most TV remote controls have recall buttons disposed close to the number buttons for allowing users to quickly switch between two channels without having to re-input the channel numbers.

When watching TV, it is common to switch the TV to another channel during commercial breaks. Since the action of switching channels is performed by the user himself/herself, the user can miss parts of the originally watched program if they forget to switch back to the original channel in time.

### SUMMARY OF THE INVENTION

Therefore, one of the objectives of the present invention is to provide a reminder system to automatically remind the user to perform a channel or signal source recall operation, and a related method, to solve the aforementioned problems.

According to an embodiment of the present invention, a channel recall reminder system is provided. The channel recall reminder system comprises a detecting device and a reminder device. The detecting device detects a channel status of a signal source to generate a detecting result. The reminder device refers to the detecting result to determine whether to provide a reminder of performing a channel recall operation.

According to another embodiment of the present invention, a signal source recall reminder system is provided. The signal source recall reminder system comprises a detecting device and a reminder device. The detecting device detects a signal receiving status of a signal source to generate a detecting result. The reminder device refers to the detecting result to determine whether to provide a reminder of performing a channel recall operation.

According to yet another embodiment of the present invention, a channel recall reminding method is provided. The channel recall reminding method comprises: utilizing a detecting device to detect a channel status of a signal source to generate a detecting result; and referring to the detecting result to determine whether to provide a reminder of performing a channel recall operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a channel recall reminder system according to a first embodiment of the present invention.

FIG. 2 is a diagram of a recall reminder system according to a second embodiment of the present invention.

FIG. 3 is a diagram of a recall reminder system according to a third embodiment of the present invention.

FIG. 4 is a flowchart of a channel recall reminding method according to an embodiment of the present invention.

FIG. 5 is a flowchart of a signal source recall method according to an embodiment of the present invention.

### DETAILED DESCRIPTION

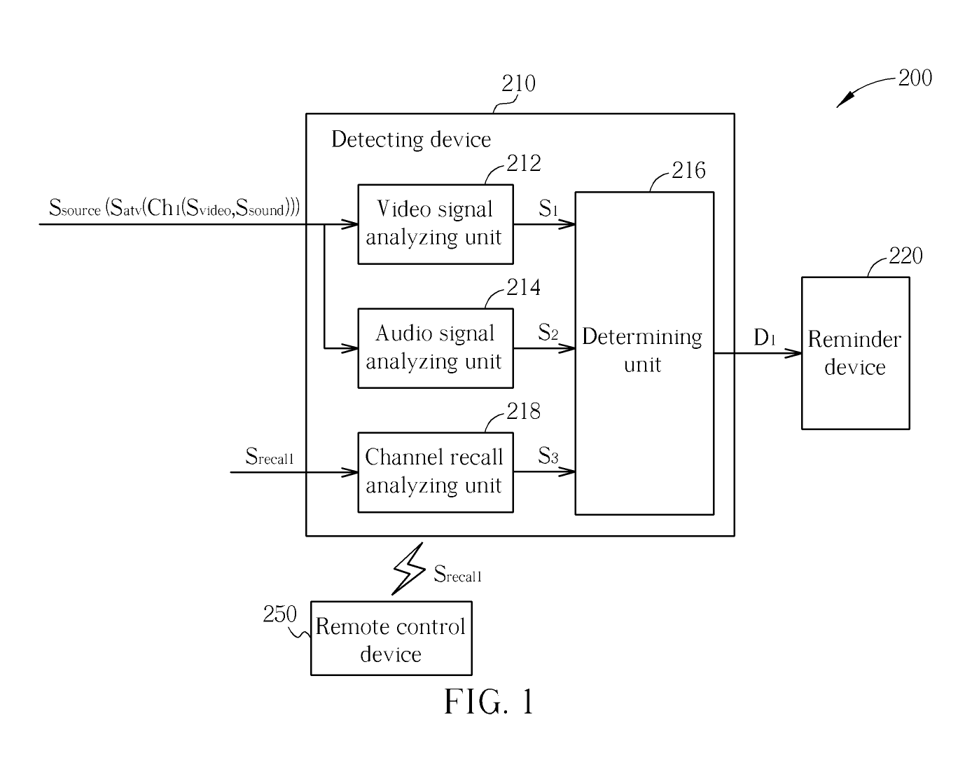

Please refer to FIG. 1, which is a diagram of a channel recall reminder system 200 according to a first embodiment of the present invention. The channel recall reminder system 200 includes a detecting device 210 and a reminder device 220. The detecting device 210 detects a channel status of a signal source S_{source} to generate a detecting result D₁. The reminder device 220 is coupled to the detecting device 210, and is for referring to the detecting result D₁ to determine whether to provide a reminder of performing a channel recall operation.

The detecting device 210 includes a video signal analyzing unit 212, an audio signal analyzing unit 214 and a determining unit 216, wherein when the detecting device 210 detects that the signal source S_{source} is switched from a first channel CH₁ to a second channel CH₂ the detecting device 210 generates the detecting result D₁ according to a signal content of the first channel CH₁. The video signal analyzing unit 212 receives a video signal S_{video} of the first channel CH₁ of the signal source S_{source}, and performs video analysis for the video signal S_{video} to generate a video analysis result S₁. The audio signal analyzing unit 214 receives an audio signal S_{sound} of the first channel CH₁ of the signal source S_{source}, and performs audio analysis for the audio signal S_{sound} to generate an audio analysis result S₂. The determining unit 216 is coupled to the video signal analyzing unit 212 and the audio signal analyzing unit 214, and is for generating the detecting result D₁ according to at least one of the video analysis result S₁ and audio analysis result S₂.

In addition, the channel recall reminder system 200 may further include a remote control device 250, and the detecting device 210 may further include a channel recall analyzing unit 218. When a user pushes a recall button of the remote control device 250, the remote control device 250 thereby transmits a recall signal S_{recall} to the channel recall analyzing unit 218. The channel recall analyzing unit 218 is coupled to the determining unit 216, and is for analyzing the recall signal S_{recall} to generate a recall analysis result S₃.

The signal source S_{source} may be an analog TV signal Sₐₜᵥ. Therefore, the video signal analyzing unit 212 receives the video signal S_{video} of the first channel Ch₁ in the analog TV signal Sₐₜᵥ, and analyzes special symbols/texts (e.g., the title and/or the subtitle of a program or a movie), special characteristics (e.g., black and white edges of a program or a movie) or opening scenes of a program or a movie within the video signal S_{video} to thereby generate the video analyzing result S₁; the audio signal analyzing unit 214 receives the audio signal S_{sound} of the first channel Ch₁ in the analog TV signal Sₐₜᵥ, and analyzes special characteristics (e.g., opening sounds of a program or a movie) within the audio signal S_{sound} to thereby generate the audio analyzing result S₂; the recall analyzing unit 218 receives the recall signal S_{recall} and analyzes the recall signal S_{recall} to calculate a channel switching frequency and a sustaining interval of a switched channel to thereby generate the recall analyzing result S₃; and the determining unit 216 receives the video analyzing result S₁, the audio analyzing result S₂ and the recall analyzing result S₃, and generates a detecting result D₁according to at least one of the video analyzing result S₁, the audio analyzing result S₂ and the recall analyzing result S₃. For example, the determining unit 216 may utilize a weighed blending method to generate the detecting result D₁ by referring to information derived from the video analyzing result S₁, the audio analyzing result S₂ and the recall analyzing result S₃ to set S₁, S₂, S₃ as values each between 0˜1, and sets weighting factors W1, W2, W3 for the analyzing results S₁, S₂, S₃ according to reliabilities of the information derived from the analyzing results S₁, S₂, S₃. When a weighted sum Wₛᵤₘ exceeds a specific threshold value, the reminder device 220 refers to the detecting result D₁ to remind the user to perform the channel recall operation. Since dramas replay for several seconds after the commercials are over, and video and audio signals of programs or movies will be repeated or continued before and after the commercials, the detecting device 210 may further include a buffer device (which is not shown in the figure) for storing the video signal S_{video} and the audio signal S_{sound} of the first channel Ch₁ in a predetermined time period, and the detecting device 210 may also further include a comparing device (which is not shown in the figure) for checking whether the stored video signal and the stored audio signal are similar to or identical with the video signal and the audio signal of the first channel Ch₁ after channel switching.

Please note that the aforementioned embodiment is for illustrative purposes only. When detecting that the signal source S_{source} is switched from the first channel Chₗ to the second channel Ch₂, the detecting device 210 may also utilize a down-count timer to trigger the reminder device 220 without performing any analysis for signals. This kind of variation in design also falls within the scope of the present invention. For instance, the down-count timer may be set to three minutes and then remind the user in due time. In this embodiment, the reminder device 220 is coupled to the detecting device 210, and may remind the user to perform the channel recall via on-screen display (OSD) or an audio reminder; however, this is not supposed to be a limitation of the present invention. For example, the reminder device 220 may be disposed on the remote control device 250 and remind the user to perform the channel recall operation via its outputs such as sound, vibration or a tactile sensation.

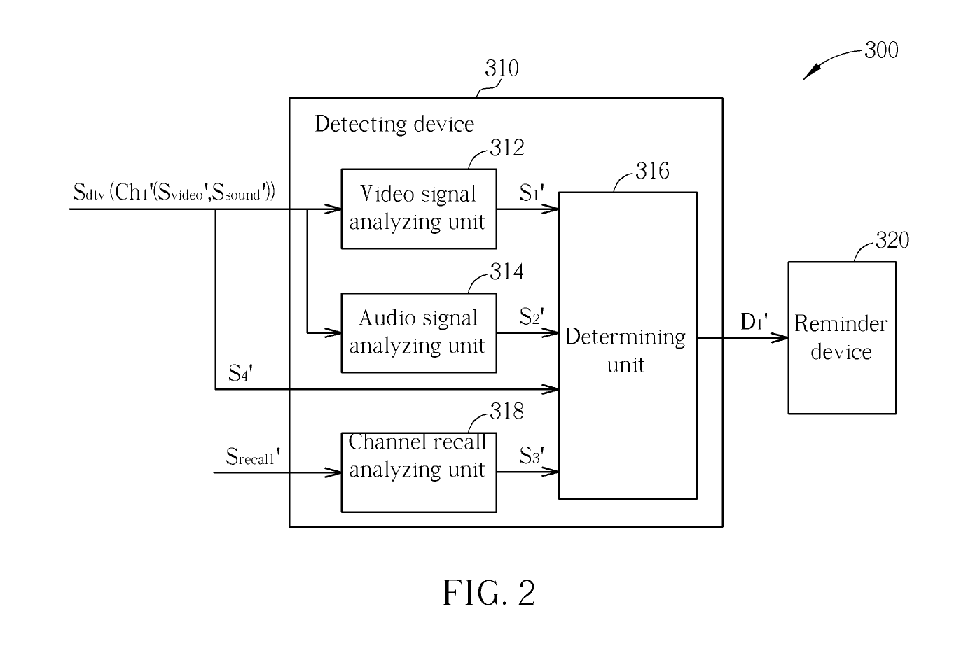

Please refer to FIG. 2, which is a diagram of a recall reminder system 300 according to a second embodiment of the present invention. In this embodiment, the signal source S_{source}′ may be a digital TV signal S_{dtv.} Since a data stream S₄′ within the digital TV signal S_{dtv}, e.g., a header of a packet, has information of program contents, it can be utilized to determine whether a commercial time in a program is over. As in the method presented in the aforementioned embodiment, the determining unit 316 can refer to at least one of the video analyzing result S₁′ generated from the video signal analyzing unit 312, the audio analyzing result S₂′ generated from the audio signal analyzing unit 314, the recall analyzing result S₃40 generated from the channel recall analyzing unit 318 and the data stream S⁴40 within the digital TV signal S_{dtv} to generate the detecting result D₁′; likewise, the determining unit 316 can also utilize the weighted blending method to generate the detecting result D₁′. The reminder 320 reminds the user to perform the channel recall operation according to the detecting result D₁′.

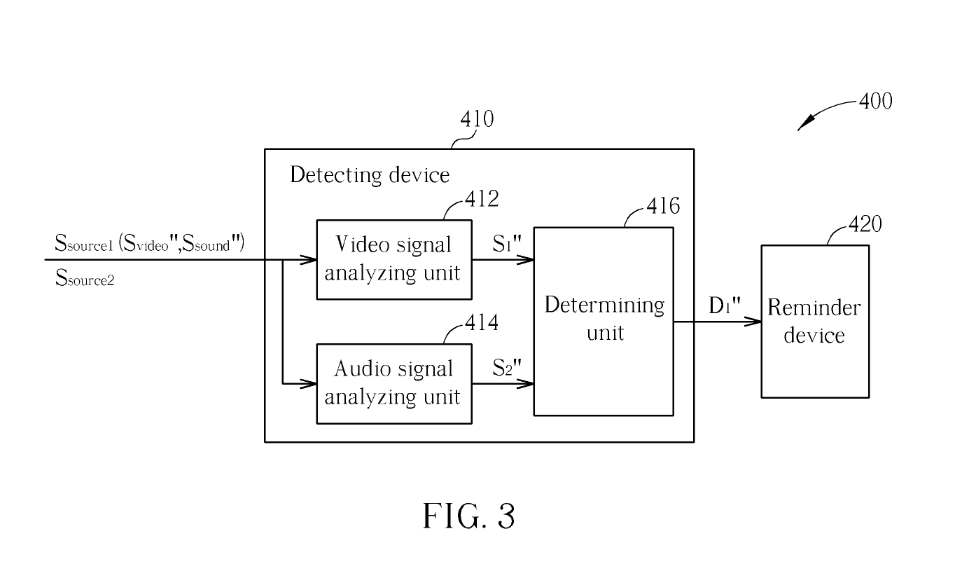

Please refer to FIG. 3, which is a diagram of a recall reminder system 400 according to a third embodiment of the present invention. The signal source recall reminder system 400 includes a detecting device 410 and a reminder device 420. The detecting device 410 is for detecting a signal receiving status of a signal source to generate a detecting result D₁″, and the reminder device 420 refers to the detecting result D₁″ to determine whether to provide a reminder of performing a signal source recall operation. When the detecting device 410 detects that a receiving status of a signal source is switched from a first signal source S_{source1} to a second signal source S_{source2}, the determining device 416, which also employs a method identical with that used in the aforementioned embodiment, refers to at least one of a video analyzing result S₁″ and an audio analyzing result S₂″ to generate a detecting result D₁″; likewise, the determining unit 416 can also utilize a weighted blending method to generate the detecting result D₁″. In another embodiment, the first signal source S_{source1} may be a digital TV signal (the arrow from S_{source1} to the determining unit 416 is not shown in the figure), and the second signal source S_{source2} may be a personal computer signal. Since a data stream within the digital TV signal S_{dtv}, e.g., a header of a packet, has information of program contents, it can be utilized to determine whether a commercial time in a program is over or not. Moreover, since dramas replay for several seconds after the commercials are over, and video and audio signals of programs or movies will be repeated or continued before and after commercials, the detecting device 410 may further include a buffer device (which is not shown in the figure) for storing a video signal S_{video}″ and an audio signal S_{sound}″ of the first signal source S_{source1} for a predetermined time, and the detecting device 410 may also further include a comparing device (which is not shown in the figure) for checking whether the stored video signal and the stored audio signal is similar to or identical with the video signal and the audio signal of the first signal source S_{source1} after signal source switching. When the detecting device 410 detects that the receiving status of the signal source is switched from the first signal source S_{source1} to the second signal source S_{source2}, the detecting device 410 may utilize a down-count timer to trigger the reminder device 420 directly.

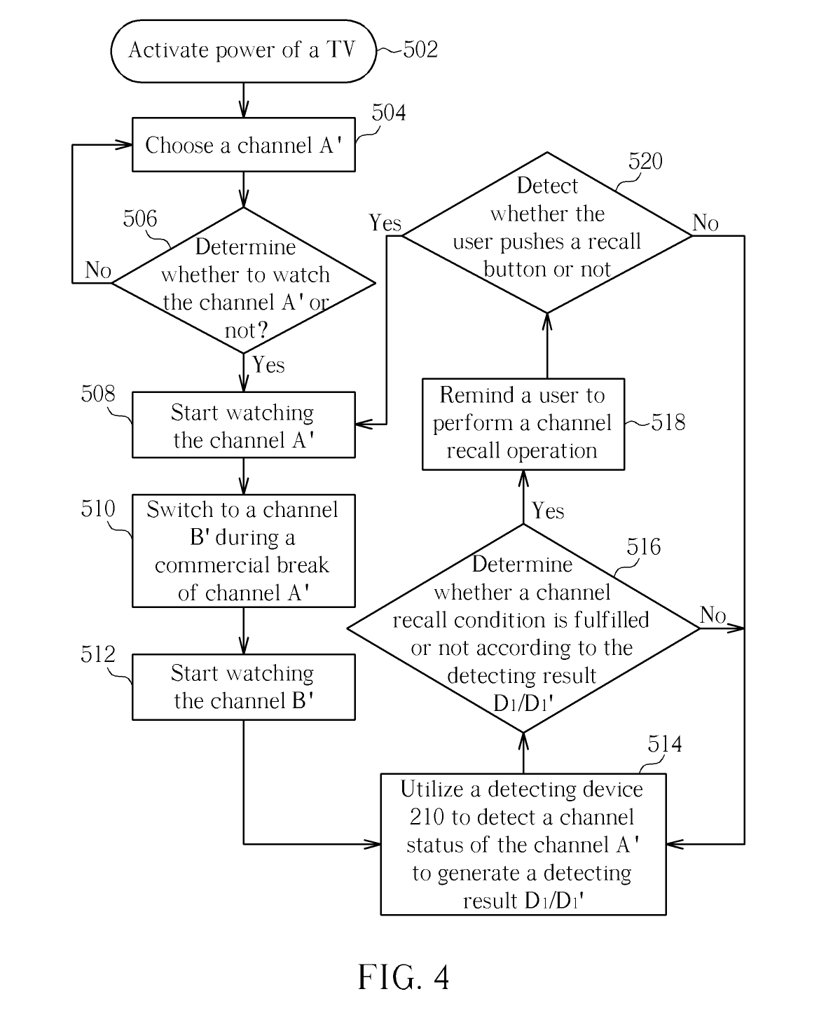

Please refer to FIG. 4, which is a flowchart of a channel recall reminding method according to an embodiment of the present invention. Please note that, if the result is substantially the same, the steps are not required to be executed in the exact order shown in FIG. 4. In addition, the steps in FIG. 4 are not required to be executed sequentially, i.e., other steps can be inserted in between. The steps are detailed as follows:

Step 502: Activate power of a TV.

Step 504: Choose a channel A′.

Step 506: Determine whether to watch the channel A′ or not. If it is determined that the channel A′ is watched, go to step 508; otherwise, go back to step 504.

Step 508: Start watching the channel A′.

Step 510: Switch to a channel B′ during a commercial break of channel A′.

Step 512: Start watching the channel B′.

Step 514: Utilize a detecting device 210 to detect a channel status of the channel A′ to generate a detecting result D₁/D₁′.

Step 516: Determine whether a channel recall condition is fulfilled or not according to the detecting result D₁ /D₁′; if the channel recall condition is fulfilled, go to step 518; otherwise, go back to step 514.

Step 518: Remind a user to perform a channel recall operation.

Step 520: Detect whether the user pushes a recall button or not. If the user pushes the recall button, go to step 508; otherwise, go back to step 514.

In step 514, when the detecting device 210 detects that the TV is switched from the channel A′ to the channel B′, the detecting result D1/D1′ is generated via analyzing a signal content within the channel A′. Since a person skilled in the pertinent art should be able to understand operations of the steps in FIG. 4 after reading the above paragraphs directed to the channel recall reminder system 200 shown in FIG. 1, further description is omitted here for brevity.

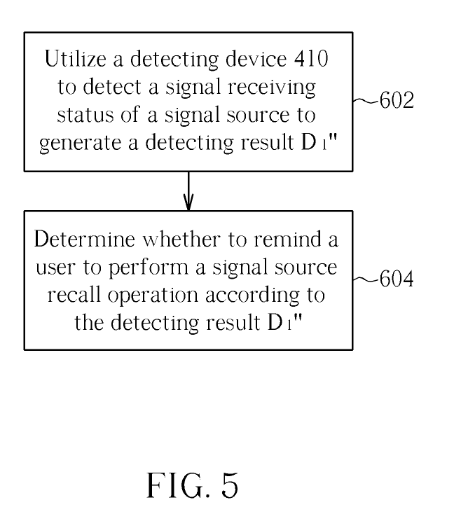

Please refer to FIG. 5, which is a flowchart of a signal source recall method according to an embodiment of the present invention. Please note that, if the result is substantially the same, the steps are not required to be executed in the exact order shown in FIG. 5. In addition, the steps in FIG. 5 are not required to be executed sequentially, i.e., other steps can be inserted in between. The steps are detailed as follows:

Step 602: Utilize a detecting device 410 to detect a signal receiving status of a signal source to generate a detecting result D₁″.

Step 604: Determine whether to remind a user to perform a signal source recall operation according to the detecting result D₁″.

In step 602, when the detecting device 410 detects that the receiving status of a signal source is switched from a first signal source S_{source1} to a second signal source S_{source2}, the detecting result D₁″ is generated via analyzing a signal content of the first signal source S_{source1}. Since a person skilled in the pertinent art should be able to understand operations of the steps in FIG. 5 after reading the above paragraphs directed to the signal source recall reminder system 400 shown in FIG. 3, further description is omitted here for brevity.

To summarize, the prevent invention provides a reminder system capable of automatically reminding the user to perform a channel or signal source recall operation and the method thereof. Via analyzing a signal content within the original channel of the signal source, outputs such as sounds, vibration or tactile sensations may be utilized to remind the user to perform the channel or signal source recall operation. In this way, the situation in which the user forgets to switch back to the originally watched channel or signal source can be avoided.

Those skilled in the art will readily observe that numerous modifications and alterations of the device and method may be made while retaining the teachings of the invention.

What is claimed is:

1. A channel recall reminder system, comprising:
a detecting device, for detecting a channel status of a signal source to generate a detecting result; and
a reminder device, coupled to the detecting device, for referring to the detecting result to determine whether to provide a reminder of performing a channel recall operation.

2. The channel recall reminder system of claim 1, wherein after the detecting device detects that the signal source is switched from a first channel to a second channel, the detecting device generates the detecting result according to a signal content of the first channel.

3. The channel recall reminder system of claim 2, wherein the signal source is a digital television signal, and the detecting device analyzes a header of a packet of the signal content to generate the detecting result.

4. The channel recall reminder system of claim 2, wherein the detecting device generate the detecting result according to whether a commercial of the first channel is over.

5. The channel recall reminder system of claim 2, wherein the detecting device comprises:
a buffer device, for buffering the signal content of the first channel before the signal source is switched from the first channel to the second channel to generate a stored signal content; and
a comparing device, for comparing the stored signal content and the signal content to generate the detecting result.

6. The channel recall reminder system of claim 1, wherein the detecting device utilizes a down-count timer to generate the detecting result when the signal source is switched from the first channel to the second channel.

7. A signal source recall reminder system, comprising:
a detecting device, for detecting a signal receiving status of a signal source to generate a detecting result; and
a reminder device, coupled to the detecting device, for referring to the detecting result to determine whether to provide a reminder of performing a signal source recall operation.

8. The signal source recall reminder system of claim 7, wherein after detecting that the signal source is switched from a first signal source to a second signal source, the detecting device generates the detecting result by analyzing a signal content of the first signal source.

9. The signal source recall reminder system of claim 8, wherein the first signal source is a digital television signal, and the detecting device analyzes a header of a packet of the signal content of the digital television signal to generate the detecting result.

10. The signal source recall reminder system of claim 8, wherein the detecting device generate the detecting result according to whether a commercial of the first signal source is over.

11. The signal source recall reminder system of claim 8, wherein the detecting device comprises:
a buffer device, for buffering the signal content of the first signal source before the signal source is switched from the first signal source to the second signal source to generate a stored signal content; and
a comparing device, for comparing the stored signal content and the signal content to generate the detecting result.

12. The signal source recall reminder system of claim 7, wherein the detecting device utilizes a down-count timer to generate the detecting result when the signal source is switched from the first signal source to the second signal source.

13. A channel recall reminding method, comprising:
utilizing a detecting device to detect a channel status of a signal source to generate a detecting result; and
referring to the detecting result to determine whether to provide a reminder of performing a channel recall operation.

14. The channel recall reminding method of claim 13, wherein the step of detecting the channel status of the signal source to generate the detecting result comprises:
detecting whether the signal source is switched from a first channel to a second channel; and
analyzing a signal content of the first channel to generate the detecting result.

15. The channel recall reminding method of claim 14, wherein the signal source is a digital television signal, and the step of detecting the channel status of the signal source to generate the detecting result comprises:
generating the detecting result by analyzing a header of a packet of the signal content of the first channel.

16. The channel recall reminding method of claim 14, wherein the step of analyzing the signal content of the first channel to generate the detecting result comprises:
generating the detecting result according to whether a commercial of the first channel is over.

17. The channel recall reminding method of claim 14, wherein the step of analyzing the signal content of the first channel to generate the detecting result comprises:
generating a stored signal content by buffering the signal content of the first channel before the signal source is switched from the first channel to the second channel; and
generating the detecting result by comparing the stored signal content and the signal content.

18. The channel recall reminding method of claim 13, wherein the step of detecting the channel status of the signal source to generate the detecting result comprises:
detecting whether the signal source is switched from the first channel to the second channel; and
utilizing a down-count timer to generate the detecting result.
